(19) United States
(12) Patent Application Publication
(10) Pub. No.: US 2026/0191319 A1
(43) Pub. Date: Jul. 9, 2026

(54) ROLLER BRUSH AND CLEANING DEVICE

(71) Applicant: BEIJING ROBOROCK TECHNOLOGY CO., LTD., Beijing (CN)

(72) Inventor: Youcheng LU, Beijing (CN)

(73) Assignee: BEIJING ROBOROCK TECHNOLOGY CO., LTD., Beijing (CN)

(21) Appl. No.: 19/552,673

(22) Filed: Feb. 27, 2026

Related U.S. Application Data
(63) Continuation of application No. PCT/CN2024/126093, filed on Oct. 21, 2024.

(30) Foreign Application Priority Data
Aug. 29, 2023 (CN) 202311100331.8

(51) Int. Cl. A46B 13/00; A46B 5/00; A46B 13/02; A47L 11/30; A47L 11/40; G10K 11/162

(52) U.S. Cl. CPC A46B 13/005; A46B 5/0012; A46B 13/02; A47L 11/302; A47L 11/4041; G10K 11/162; A46B 2200/3033

(57) ABSTRACT

A roller brush and a cleaning device are provided. The roller brush includes: a shaft rod; and a brush member coaxially arranged on an outer side of the shaft rod and configured to clean an operating surface as the roller brush rotates. At least part of an outer surface of the brush member is provided with a noise reducing film layer, and the noise reducing film layer is configured to reduce noise generated when the operating surface is cleaned.

### CROSS-REFERENCE TO RELATED APPLICATIONS

This application is a continuation of International Application No. PCT/CN2024/126093 filed on Oct. 21, 2024, which claims priority to Chinese Patent Application No. 202311100331.8 filed on Aug. 29, 2023, which are incorporated herein by reference in their entireties.

### TECHNICAL FIELD

The present disclosure relates to the technical field of cleaning devices, and in particular, to a roller brush and a cleaning device.

### BACKGROUND

With the continuous development of science and technology, cleaning devices, such as sweeping robots and sweeping and mopping integrated machines, have been widely used in homes. For a cleaning robot with a sweeping function, in order to implement the sweeping function, a roller brush is provided to roll up the garbage of different sizes on the ground and suck the garbage into a garbage collection box.

The structure and arrangement of the roller brush have become one of the important factors affecting the cleaning effect of the cleaning device.

It should be noted that the information disclosed in the above background section is only used for enhancement of understanding of the background of the present disclosure and therefore may include information that does not constitute the prior art known to those of ordinary skill in the art.

### SUMMARY

The present disclosure provides a roller brush. The roller brush includes:
a shaft rod; and a brush member coaxially arranged on an outer side of the shaft rod and configured to clean the operating surface as the roller brush rotates,
where at least part of an outer surface of the brush member is provided with a noise reducing film layer, and the noise reducing film layer is configured to reduce noise generated when the operating surface is cleaned.

### BRIEF DESCRIPTION OF THE DRAWINGS

The drawings, which are incorporated into and constitute a part of the specification, illustrate embodiments consistent with the present disclosure and are used in conjunction with the specification to explain the principles of the present disclosure. Apparently, the drawings in the following description are merely some embodiments of the present disclosure, and those of ordinary skill in the art may still derive other drawings from these drawings without creative efforts.

FIG. 1 is a schematic diagram of a three-dimensional structure of a cleaning device according to some embodiments of the present disclosure.

FIG. 2 is a schematic bottom view of a cleaning device according to some embodiments of the present disclosure.

FIG. 3 is a schematic structural diagram of a cleaning module according to some embodiments of the present disclosure.

FIG. 4 is a schematic cross-sectional view of a cleaning module according to some embodiments of the present disclosure.

FIG. 5 is a longitudinal schematic cross-sectional view of a roller brush according to some embodiments of the present disclosure.

### DETAILED DESCRIPTION

For clearer descriptions of the objectives, technical solutions, and advantages of the present disclosure, the present disclosure is further described in detail hereinafter with reference to the drawings. Apparently, the described embodiments are merely some embodiments of the present disclosure, rather than all of the embodiments. Based on the embodiments in the present disclosure, all other embodiments obtained by those of ordinary skill in the art without creative efforts shall fall within the scope of protection of the present disclosure.

It should be further noted that the terms “comprise”, “include”, or any other variants thereof are intended to encompass a non-exclusive inclusion, such that a commodity or an apparatus including a list of elements includes not only those elements, but also other elements not explicitly listed or elements inherent to such commodity or apparatus. Without further limitation, an element defined by the phrase “comprising a/an . . . ” or “including a/an . . . ” does not exclude the presence of other identical elements in the commodity or apparatus including the element.

In the related art, the cleaning device (specifically, a roller brush of the cleaning device), such as a sweeping robot, may generate an uncomfortable sound when cleaning the operating surface, causing discomfort to the user and affecting the user experience.

One embodiment of the present disclosure provides a roller brush. The roller brush includes a shaft rod and a brush member coaxially arranged on an outer side of the shaft rod and configured to clean an operating surface as the roller brush rotates. At least part of an outer surface of the brush member is provided with a noise reducing film layer, and the noise reducing film layer is configured to reduce the noise generated when the operating surface is cleaned.

According to the roller brush provided in the embodiments of the present disclosure, by providing the noise reducing film layer on at least part of the outer surface of the brush member, the noise generated when the operating surface is cleaned is reduced, and the user experience during cleaning by the roller brush is improved.

Some embodiments of the present disclosure will be described in detail hereinafter with reference to the drawings.

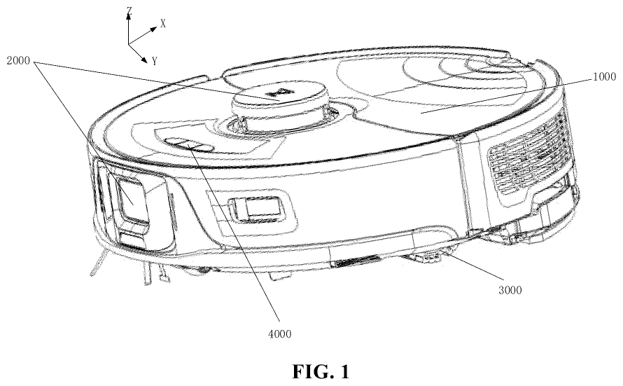

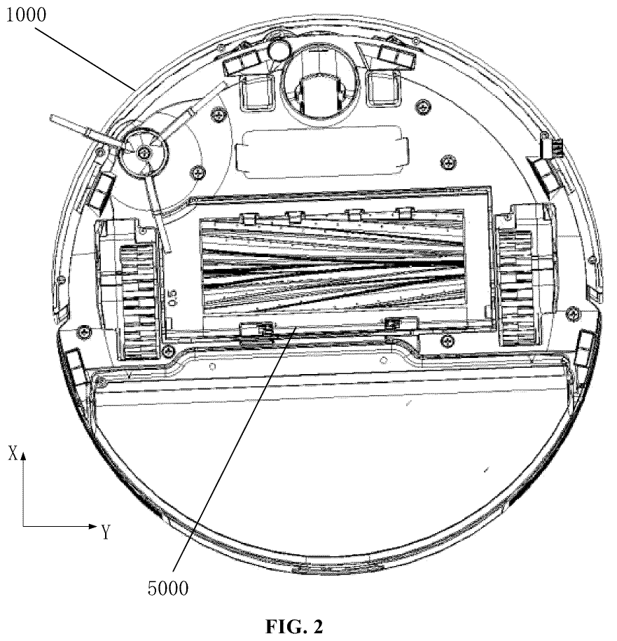

FIGS. 1 and 2 are schematic structural diagrams of a cleaning device according to one exemplary embodiment. The roller brush according to one embodiment of the present disclosure is applicable to the cleaning device. As an example, the cleaning device may be a robot vacuum cleaner, a mopping/scrubbing robot, a window cleaning robot, or the like. The cleaning device may include a mobile platform 1000, a sensing system 2000, a control system (not shown in the figure), a driving system 3000, a power system (not shown in the figure), a human-machine interaction system 4000, and a cleaning module 5000.

The mobile platform 1000 may be configured to move in a target direction on an operating surface. The operating surface may be a surface to be cleaned by the cleaning device. In some embodiments, the cleaning device may be a mopping robot, the cleaning device operates on the ground, and the ground serves as the operating surface. The cleaning device may also be a window cleaning robot, the cleaning device operates on an outer surface of a glass of a building, and the glass serves as the operating surface. The cleaning device may further be a pipeline cleaning robot, the cleaning device operates on an inner surface of a pipeline, and the inner surface of the pipeline serves as the operating surface. For the purpose of illustration only, the following description in the present disclosure is illustrated by taking a mopping robot as an example.

In some embodiments, the mobile platform 1000 may be an autonomous mobile platform or a non-autonomous mobile platform. The autonomous mobile platform means that the mobile platform 1000 itself can adaptively make an operational decision based on an unexpected environmental input; and the non-autonomous mobile platform itself cannot adaptively make an operational decision based on an unexpected environmental input, but can execute a given procedure or operate according to a certain logic. Correspondingly, when the mobile platform 1000 is an autonomous mobile platform, the target direction may be autonomously determined by the cleaning device; and when the mobile platform 1000 is a non-autonomous mobile platform, the target direction may be set systematically or manually.

The sensing system 2000 includes sensing apparatuses such as a position determining apparatus (not shown in the figure) located above the mobile platform 1000, a buffer (not shown in the figure) located in a forward portion of the mobile platform 1000, a cliff sensor (not shown in the figure) and an ultrasonic sensor (not shown in the figure) located at the bottom of the mobile platform, an infrared sensor (not shown in the figure), a magnetometer (not shown in the figure), an accelerometer (not shown in the figure), a gyroscope (not shown in the figure), and an odometer (not shown in the figure), to provide various position information and motion status information of the machine to the control system.

For convenience of description, directions are defined as follows: The cleaning device may be calibrated by defining the following three axes perpendicular to one another: a transverse axis Y, a front-rear axis X, and a vertical axis Z. A direction to which an arrow along the front-rear axis X points is marked as “rearward”, and a direction opposite to the direction of the arrow along the front-rear axis X is marked as “forward”. The transverse axis Y is substantially in the width direction of the cleaning device. A direction of an arrow along the transverse axis Y is marked as “leftward”, and a direction opposite to the direction of the arrow along the transverse axis Y is marked as “rightward”. The vertical axis Z is a direction extending upward from the bottom surface of the cleaning device. As shown in FIG. 1, a direction along the front-rear axis X is defined as a second direction, where the second direction is, for example, a forward direction or a rearward direction; and a direction perpendicular to the second direction in a horizontal plane is defined as a first direction, where the first direction is, for example, a leftward direction or a rightward direction.

The control system (not shown in the figure) is disposed on a main circuit board in the mobile platform 1000, and includes a computing processor, such as a central processing unit or an application processor, that communicates with a non-transitory memory, such as a hard disk, a flash memory, or a random access memory. The application processor is configured to receive environmental information sensed by a plurality of sensors and transmitted from the sensing system, draw a real-time map of an environment in which the cleaning device is located by using a positioning algorithm, such as SLAM based on obstacle information fed back by the position determining apparatus, etc., autonomously determine a travel path based on the environmental information and the environmental map, and then control the driving system 3000 to perform operations such as traveling forward, traveling rearward, and/or steering according to the autonomously determined travel path. Further, the control system may also determine whether to activate the cleaning module 5000 to perform a cleaning operation based on the environmental information and the environmental map.

The driving system 3000 may execute a driving command based on specific distance and angle information, for example, x, y, and θ components, to steer the cleaning device to run across the ground. The driving system 3000 includes a driving wheel assembly. The driving system 3000 may simultaneously control a left wheel and a right wheel. To more precisely control the movement of the machine, the driving system 3000 may include a left driving wheel assembly and a right driving wheel assembly. The left and right driving wheel assemblies are symmetrically arranged along a transverse axis defined by the mobile platform 1000. To enable the cleaning device to move more stably on the ground or to achieve stronger mobility, the cleaning device may include one or more steering assemblies. Each steering assembly may be either a driven wheel or a driving wheel, and may adopt structural forms including but not limited to a universal wheel. The steering assembly may be located in front of the driving wheel assembly.

The power system (not shown in the figure) includes a rechargeable battery, for example, a nickel-hydrogen battery and a lithium battery. The rechargeable battery may be connected to a charging control circuit, a battery pack charging temperature detection circuit, and a battery undervoltage monitoring circuit. The charging control circuit, the battery pack charging temperature detection circuit, and the battery undervoltage monitoring circuit are then connected to a single-chip microcomputer control circuit. The main unit is charged through connection to a charging pile via charging electrodes disposed on the side or bottom of the machine body.

The human-machine interaction system 4000 includes a button on a main unit panel for a user to select a function, and may also include a display screen and/or an indicator light and/or a speaker, where the display screen, the indicator light, and the speaker show a current state of the machine or function options to the user, and may also include a mobile phone client program. For a path navigation type cleaning device, a mobile phone client may show a map of an environment in which the device is located and a location of the machine to the user, providing the user with richer and more user-friendly function options.

FIG. 2 is a schematic bottom view of the cleaning device in FIG. 1. As shown in FIG. 2, the cleaning module 5000 is mounted on the mobile platform 1000, for example, disposed at the bottom of the mobile platform 1000, and is configured to clean the operating surface.

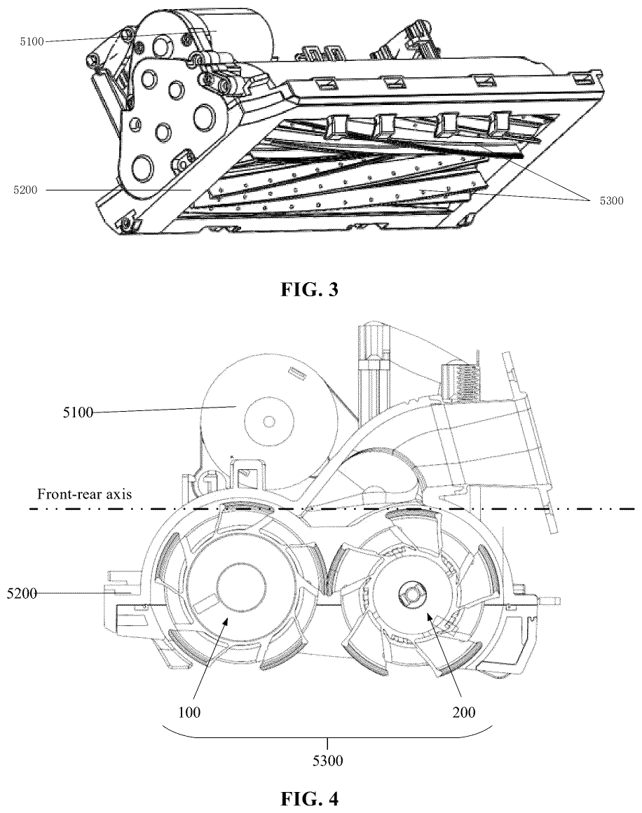

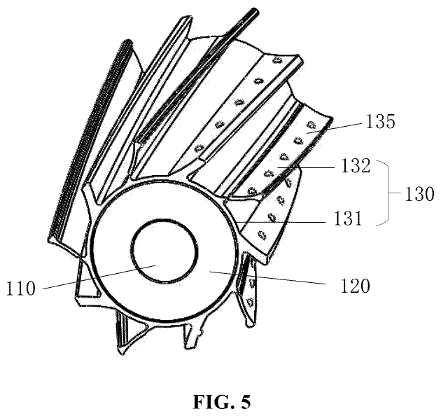

FIG. 3 is a schematic structural diagram of a cleaning module 5000 according to some embodiments of the present disclosure, and FIG. 4 is a schematic cross-sectional view of a cleaning module 5000 according to some embodiments of the present disclosure. As shown in FIGS. 3 and 4, the cleaning module 5000 further includes a drive unit 5100, a roller brush frame 5200, and a roller brush 5300 assembled in the roller brush frame 5200. The drive unit 5100 provides a driving force for forward rotation or reverse rotation, and the driving force is applied to the roller brush 5300 through a multi-stage gear set. The roller brush 5300 rotates under the action of the driving force to clean the operating surface, or the roller brush 5300 rotates under the action of the driving force to collect dust.

The roller brush 5300 is assembled in the roller brush frame 5200 and disposed in a first direction perpendicular to a front-rear axis of the mobile platform 1000. The number of roller brushes 5300 may be determined according to the actual situation. In some embodiments, referring to FIG. 4, two roller brushes 5300 are provided, which are a first roller brush 100 and a second roller brush 200, respectively, where the second roller brush 200 is disposed in a direction parallel to the first roller brush 100.

Referring to FIG. 5, the roller brush 5300 includes a shaft rod 110 and a brush member 130. The brush member 130 is coaxially arranged on the outer side of the shaft rod 110 and configured to clean the operating surface as the roller brush 5300 rotates. At least part of the outer surface of the brush member 130 is provided with a noise reducing film layer 135, and the noise reducing film layer 135 is configured to reduce the noise generated when the operating surface is cleaned.

At least one end of the shaft rod 110 is connected to the multi-stage gear set to receive the driving force of the drive unit 5100 and achieve forward rotation or reverse rotation. The shaft rod 110 is in the shape of a long-strip-shaped cylinder, a long-strip-shaped rectangular prism, or a long-strip-shaped polygonal prism, which is not limited herein. The shape of the long-strip-shaped cylinder is used as an example for illustration hereinafter. The axis of the shaft rod 110 may be regarded as the rotation shaft of the roller brush 100. After the roller brush 5300 is mounted to the mobile platform, the driving system can drive the shaft rod 110 to rotate, thereby driving the brush member 130 on the surface of the shaft rod 110 to sweep.

In some embodiments, the roller brush 5300 further includes a filler 120. The filler 120 is disposed between the shaft rod 110 and the brush member 130 and coaxial with the shaft rod 110. The cross-section of the filler 120 is of an annular structure, and the inner ring shape of the filler 120 matches the cross-section shape of the shaft rod 110. The inner ring shape may be circular, square, polygonal, or the like, which is not limited herein. The inner ring being in a circular shape is used as an example for illustration hereinafter. The outer ring shape of the filler 120 is generally circular. When the cross-section of the filler 120 is annular, the cross-section of the filler 120 has an inner diameter and an outer diameter. The inner diameter of the filler is substantially equal to the diameter of the shaft rod 110, so as to achieve seamless sleeved fitting between the filler 120 and the shaft rod 110. The outer diameter of the filler is substantially equal to the inner diameter of a cylindrical member 131, so as to achieve seamless sleeved fitting between the filler 120 and the cylindrical member 131.

The filler 120 is made of a compressible elastic material, for example, a sponge, an organic flexible material, a resin material, or a foam material, which will not be enumerated herein. The filler 120 has the characteristics of being compressed inward by a force and restoring to its original shape after the force is removed. In addition, the filler 120 may also be made of a hollowed-out material or structure with similar compressible characteristics, for example, a spring or an elastic plate, which will not be enumerated herein either.

The brush member 130 is sleeved over the outer side of the filler 120, and the brush member 130 includes a cylindrical member 131 and a brush component 132.

In some embodiments, the brush member 130 is formed of a soft rubber material. Specifically, in some embodiments, the brush component 132 is formed of a soft rubber material. The soft rubber material may be, for example, TPU (thermoplastic urethane), TPE (thermoplastic elastomer), rubber, or PVC (polyvinyl chloride). The soft rubber material exhibits good elasticity, which can be elastically deformed when interfering with the operating surface to clean the operating surface.

In some embodiments, the brush member 130 further includes a cylindrical member 131 and a brush component 132. The cylindrical member 131 is sleeved over the outer side of the shaft rod 110, and the brush component 133 extends from the outer surface of the cylindrical member 131 in a direction away from the cylindrical member 131. The brush component 132 is configured to interfere with the operating surface to clean the operating surface.

The cylindrical member 131 is sleeved over the outer side of the shaft rod 110 and is coaxial with the shaft rod 110. The cylindrical member 131 is generally cylindrical and has a length substantially the same as that of the shaft rod 110. The cylindrical member 131 is generally compressible. For example, the cylindrical member is made of an elastic plastic or rubber material, enabling inward compression and deformation under an external force, and recovery to its original shape after the external force is removed. The cylindrical member 131 generally has a certain thickness to enhance the overall wear resistance of the brush member 130.

In some embodiments, the roller brush 5300 further includes a filler 120. In this case, the cylindrical member 131 is sleeved over the outer side of the filler 120.

The brush component 132 extends from the outer surface of the cylindrical member 131 in a direction away from the cylindrical member 131. The brush component 132 may be a plurality of sheet-like structures, and at least one brush component 132 extends from one end of the cylindrical member 131 to the other end of the cylindrical member 131 in an axial direction of the cylindrical member 131. The brush component 132 may be in the form of blades, bristles, or the like.

In some embodiments, a plurality of brush components 132 are provided. Each brush component 132 is of a spiral structure on the outer surface of the cylindrical member 131, the plurality of brush components 132 are substantially uniformly distributed in a circumferential direction of the cylindrical member 131, and the spiral structures of the plurality of brush components 132 are substantially parallel. By designing the brush component 132 as a spiral structure, garbage can be easily rolled up when the front and rear roller brushes rotate oppositely, avoiding damage to the brush component 132 due to excessive impact force, thereby extending the service life.

The noise reducing film layer 135 is disposed on at least a partial area of the outer surface of the brush member 130 to reduce the noise generated when the brush member 130 cleans the operating surface. In some embodiments, the noise reducing film layer 135 is at least disposed on a portion of the brush component 132 that interferes with the operating surface to reduce the noise generated when the brush component 132 interferes with the operating surface. In some other embodiments, the noise reducing film layer 135 is disposed on the outer surface of the cylindrical member 131 and the outer surface of the brush component 132.

In some embodiments, a coefficient of friction between the noise reducing film layer 135 and the operating surface is less than a coefficient of friction between the brush component 132 and the operating surface, and specifically, may be less than the coefficient of friction between the portion of the brush component 132 that interferes with the operating surface and the operating surface, such that the friction force between the brush component 132 provided with the noise reducing film layer 135 and the operating surface is less than the friction force between the brush component 132 not provided with the noise reducing film layer 135 and the operating surface. It can be seen that when the surface of the brush component 132 of the roller brush 5300 is provided with the noise reducing film layer 135, the friction force between the brush component 132 and the operating surface is reduced, thereby reducing the noise between the roller brush 5300 and the operating surface. In some embodiments, the coefficient of friction of the noise reducing film layer 135 is less than a preset coefficient of friction value.

In some embodiments, a smoothness of the noise reducing film layer 135 is greater than a smoothness of the brush component 132, and specifically, may be less than the smoothness of the portion of the brush component 132 that interferes with the operating surface. By forming a smooth film layer on the surface of the brush component 132, the noise between the roller brush 5300 and the operating surface can be reduced.

In some embodiments, an elastic modulus of the noise reducing film layer 135 is greater than an elastic modulus of the brush component 132, such that the deformation of the brush component 132 provided with the noise reducing film layer 135 when colliding with the operating surface is greater than the deformation of the brush component 132 not provided with the noise reducing film layer 135 when colliding with the operating surface, thereby reducing the noise between the brush component 132 and the operating surface. In some embodiments, the elastic modulus of the noise reducing film layer 135 is greater than a preset elastic modulus value.

In some embodiments, the coefficient of friction between the noise reducing film layer 135 and the operating surface is less than the coefficient of friction between the brush component 132 and the operating surface, and the elastic modulus of the noise reducing film layer 135 is greater than the elastic modulus of the brush component 132. For example, the coefficient of friction of the noise reducing film layer 135 is set to be less than a preset coefficient of friction value, and the elastic modulus of the noise reducing film layer 135 is set to be greater than a preset elastic modulus value.

In some embodiments, the noise reducing film layer 135 may be at least one of a parylene film and a Teflon (or referred to as polytetrafluoroethylene, PTFE) film. The film made of the above parylene and Teflon can improve the smoothness of the surface of the brush component 132, reduce the friction force between the surface of the brush component 132 and the operating surface, and thereby reduce the noise between the roller brush 5300 and the operating surface when the roller brush rolls.

In some embodiments, the thickness of the noise reducing film layer 135 may range from 0.05 μm to 0.3 μm. If the thickness of the noise reducing film layer 135 is excessively large, the overall thickness and elasticity of the brush component 132 may be affected, and the excessively thick noise reducing film layer 135 tends to detach from the surface of the brush component 132. If the thickness of the noise reducing film layer 135 is excessively small, the film layer becomes less wear-resistant, affecting the noise cancellation effect.

In some embodiments, the noise reducing film layer 135 is formed by a chemical vapor deposition (chemical vapor deposition, CVD) method. Specifically, the chemical vapor deposition method may adopt a vacuum nanocoating film deposition preparation process. The formation of a parylene film on the surface of the brush member 130 by the chemical vapor deposition method is used as an example for illustration hereinafter. The whole process of chemical vapor deposition needs to be performed under a vacuum condition. The dimer of p-xylene is decomposed into reactive monomers at a high temperature. The reactive monomers are deposited and polymerized on the surface of an object (for example, the surface of the brush member 130) to form a layer of film covering the entire surface. The chemical vapor deposition method can be applied to coat surfaces of any shape, without leaving any dead corners. The surfaces of any shape include sharp edges, the interior of gaps, and extremely fine pinholes. Moreover, the film deposited by the chemical vapor deposition method on any part of the product exhibits highly uniform thickness. The parylene film prepared by the chemical vapor deposition method has a thickness of 0.05-0.3 μm.

In some embodiments, the noise reducing film layer 135 is achieved by a process such as spraying, brushing, or roll coating. Spraying is performed by using a spray gun or a disc atomizer to disperse a coating material to be sprayed into uniform and fine droplets by means of pressure or centrifugal force and apply them to the surface of an object to be coated. Brushing is performed by using a paintbrush to dip into a coating material to be brushed and apply it to the surface of an object to be coated. Roll coating is performed by using a roller brush to dip into a coating material to be roll-coated and apply it to the surface of an object to be coated.

As an example, the Teflon film may be achieved by using a surface spraying method. Teflon is a material having a very low friction force. After being sprayed onto the surface of the brush member 130, the Teflon can reduce the friction force between the brush member 130 and the operating surface to achieve noise cancellation.

One embodiment of the present disclosure further provides a cleaning device. The cleaning device includes the aforementioned roller brush 5300.

In some embodiments, the cleaning device includes a mobile platform configured to move on an operating surface and a cleaning module mounted on the mobile platform and configured to clean the operating surface. The cleaning module includes a roller brush disposed in a first direction perpendicular to a front-rear axis of the mobile platform.

The roller brush includes a shaft rod and a brush member. The brush member is coaxially arranged on an outer side of the shaft rod and configured to clean the operating surface as the roller brush rotates. At least part of an outer surface of the brush member is provided with a noise reducing film layer, and the noise reducing film layer is configured to reduce the noise generated when the operating surface is cleaned.

According to the roller brush and the cleaning device provided in the embodiments of the present disclosure, by providing the noise reducing film layer on at least part of the outer surface of the brush member, the noise generated when the operating surface is cleaned is reduced, and the user experience during cleaning by the roller brush and the cleaning device is improved.

It should be noted that the embodiments in the specification are described in a progressive manner, and each embodiment focuses on differences from other embodiments, and reference should be made to each other for the same or similar parts. Since the system or apparatus disclosed in the embodiments corresponds to the method disclosed in the embodiments, the description is relatively simple, and reference may be made to the description of the method part for relevant details.

The above embodiments are only used to illustrate the technical solutions of the present disclosure, but not to limit them; although the present disclosure has been described in detail with reference to the foregoing embodiments, those of ordinary skill in the art should understand that they can still modify the technical solutions recorded in the foregoing embodiments, or make equivalent substitutions for some of the technical features; and these modifications or substitutions do not make the essence of the corresponding technical solutions deviate from the spirit and scope of the technical solutions in the embodiments of the present disclosure.

1. A roller brush, comprising:
a shaft rod; and
a brush member coaxially arranged on an outer side of the shaft rod and configured to clean an operating surface as the roller brush rotates,
wherein at least part of an outer surface of the brush member is provided with a noise reducing film layer, and the noise reducing film layer is configured to reduce noise generated when the operating surface is cleaned.

2. The roller brush according to claim 1, wherein the brush member comprises:
a cylindrical member sleeved over the outer side of the shaft rod; and
a brush component extending from an outer surface of the cylindrical member in a direction away from the cylindrical member and configured to interfere with the operating surface to clean the operating surface,
wherein the noise reducing film layer is at least disposed on a portion of the brush component that interferes with the operating surface.

3. The roller brush according to claim 1, wherein a coefficient of friction of the noise reducing film layer is less than a preset coefficient of friction value.

4. The roller brush according to claim 1, wherein an elastic modulus of the noise reducing film layer is greater than a preset elastic modulus value.

5. The roller brush according to claim 1, wherein
the noise reducing film layer comprises at least one of a parylene film or a Teflon film.

6. The roller brush according to claim 1, wherein
a thickness of the noise reducing film layer is 0.05-0.3 μm.

7. The roller brush according to claim 1, wherein the noise reducing film layer is provided by at least one of the following methods: chemical vapor deposition, spraying, brushing, or roll coating.

8. The roller brush according to claim 1, wherein the brush member is formed of a soft rubber material.

9. The roller brush according to claim 2, wherein a plurality of brush components are provided, and the plurality of brush components are uniformly distributed in a circumferential direction of the cylindrical member.

10. A cleaning device, comprising a roller brush, wherein the roller brush comprises:
a shaft rod; and
a brush member coaxially arranged on an outer side of the shaft rod and configured to clean an operating surface as the roller brush rotates,
wherein at least part of an outer surface of the brush member is provided with a noise reducing film layer, and the noise reducing film layer is configured to reduce noise generated when the operating surface is cleaned.

11. The cleaning device according to claim 10, wherein the brush member comprises:
a cylindrical member sleeved over the outer side of the shaft rod; and
a brush component extending from an outer surface of the cylindrical member in a direction away from the cylindrical member and configured to interfere with the operating surface to clean the operating surface,
wherein the noise reducing film layer is at least disposed on a portion of the brush component that interferes with the operating surface.

12. The cleaning device according to claim 10, wherein a coefficient of friction of the noise reducing film layer is less than a preset coefficient of friction value.

13. The cleaning device according to claim 10, wherein an elastic modulus of the noise reducing film layer is greater than a preset elastic modulus value.

14. The cleaning device according to claim 10, wherein
the noise reducing film layer comprises at least one of a parylene film or a Teflon film.

15. The cleaning device according to claim 10, wherein
a thickness of the noise reducing film layer is 0.05-0.3 μm.

16. The cleaning device according to claim 10, wherein the noise reducing film layer is provided by at least one of the following methods: chemical vapor deposition, spraying, brushing, or roll coating.

17. The cleaning device according to claim 10, wherein the brush member is formed of a soft rubber material.

18. The cleaning device according to claim 11, wherein a plurality of brush components are provided, and the plurality of brush components are uniformly distributed in a circumferential direction of the cylindrical member.
